(19) United States
(12) Patent Application Publication
(10) Pub. No.: US 2004/0225583 A1
(43) Pub. Date: Nov. 11, 2004

(54) Architecture and application return-on-investment metrics

(75) Inventor: Pirooz Joodi, Dublin, OH (US)

Correspondence Address: PAUL D. HEYDON, PATENT ATTORNEY, 3004 NACOGDOCHES ROAD, SAN ANTONIO, TX, 78217, US

(73) Assignee: International Business Machines Corporation, Armonk, NY

(21) Appl. No.: 10/434,506

(22) Filed: May 8, 2003

(51) Int. Cl. G06F 17/60

(52) U.S. Cl. 705/35

(57) ABSTRACT

An example of a solution provided here comprises receiving inputs from architectural work products, for an information-technology project, estimating a return on investment for the project, based on the inputs and a cost-benefit assessment, and outputting results of the estimating. The estimating includes estimating cost quantities and benefit quantities for two or more years.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to information handling, and more particularly to handling information that is usable in an estimation process.

### BACKGROUND OF THE INVENTION

Organizations who will pay for receiving the benefit of a proposed information-technology project, need to estimate accurately the return on investment for the proposed project. So do those providing services, or delivering a mixture of goods and services, related to the project. Typically, some guidance exists in the form of a design, diagram, documentation, model, or specification for the proposed project. These may be difficult to adapt and use, for obtaining accurate estimates of a return on investment, however. This problem is not addressed by other estimation examples that focus on different matters. Thus there is a need for a tool to bridge the gap between a project's documentation and an estimated return on investment.

### SUMMARY OF THE INVENTION

An example of a solution to problems mentioned above comprises receiving inputs from architectural work products, for an information-technology project, estimating a return on investment for the project, based on the inputs and a cost-benefit assessment, and outputting results of the estimating. The estimating includes estimating cost quantities and benefit quantities for two or more years.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIG. 2 is a flow chart showing an example of a process for estimating, according to the teachings of the present invention.

FIG. 3 is a block diagram showing an example of a system and method for estimating, according to the teachings of the present invention.

### DETAILED DESCRIPTION

The examples that follow involve the use of one or more computers and may involve the use of one or more communications networks. The present invention is not limited as to the type of computer on which it runs, and not limited as to the type of network used. The present invention is not limited as to the type of medium or format used for input and output. These may include sketching diagrams by hand on paper, printing images or numbers on paper, displaying images or numbers on a screen, or some combination of these, for example. A model of a solution might be provided on paper, and later the model could be the basis for a design implemented via computer, for example.

The following are definitions of terms used in the description of the present invention and in the claims:

“Application” means any specific use for computer technology, or any software that allows a specific use for computer technology.

“Architectural work product” means any design, diagram, document, model, or specification for any software or system.

“Availability” means ability to be accessed or used.

“Business process” means any process involving use of a computer by any enterprise, group, or organization; the process may involve providing goods or services of any kind.

“Client-server application” means any application involving a client that utilizes a service, and a server that provides a service. Examples of such a service include but are not limited to: information services, transactional services, access to databases, and access to audio or video content.

“Comparing” means bringing together for the purpose of finding any likeness or difference, including a qualitative or quantitative likeness or difference.

“Component” means any element or part, and may include elements consisting of hardware or software or both.

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“Cost-benefit assessment” means any comparison or evaluation involving costs and benefits.

“Mapped” or “Mapping” refers to associating, matching or correlating.

“Project” means any assignment, enterprise, job, undertaking or venture, in any industry or profession; for example, it may involve providing services, or a mixture of goods and services.

“Return on Investment” means an amount of income or any other economic benefit, compared to an amount of money invested in assets.

“Storing” data or information, using a computer, means placing the data or information, for any length of time, in any kind of computer memory, such as floppy disks, hard disks, Random Access Memory (RAM), Read Only Memory (ROM), CD-ROM, flash

ROM, non-volatile ROM, and non-volatile memory.

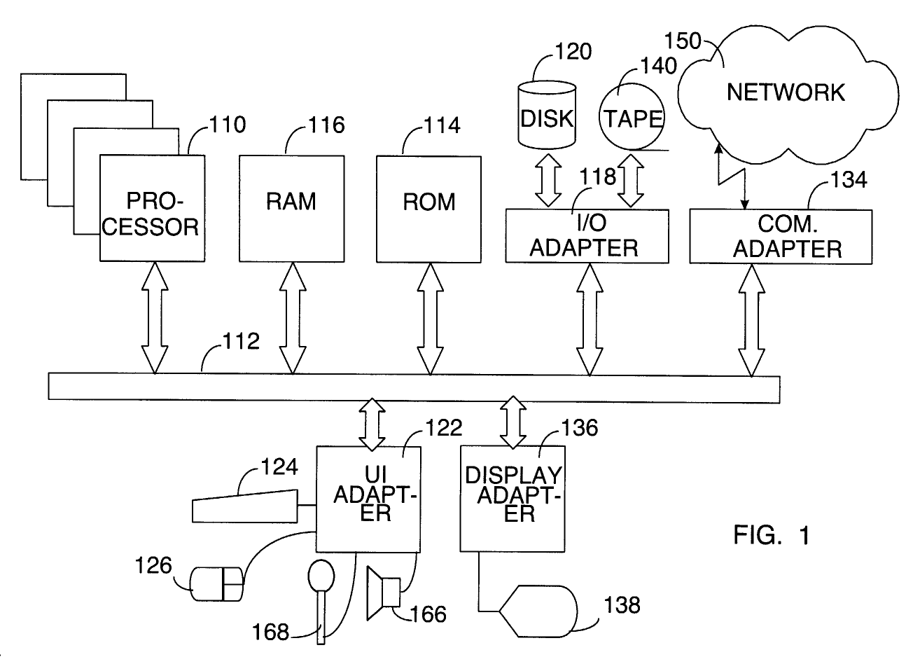

FIG. 1 illustrates a simplified example of an information handling system that may be used to practice the present invention. The invention may be implemented on a variety of hardware platforms, including embedded systems, personal computers, workstations, servers, and mainframes. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112. The system has user interface adapter 122 for connecting keyboard 124, mouse 126, or other user interface devices such as audio output device 166 and audio input device 168 to bus 112. The system has communication adapter 134 for connecting the information handling system to a communications network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

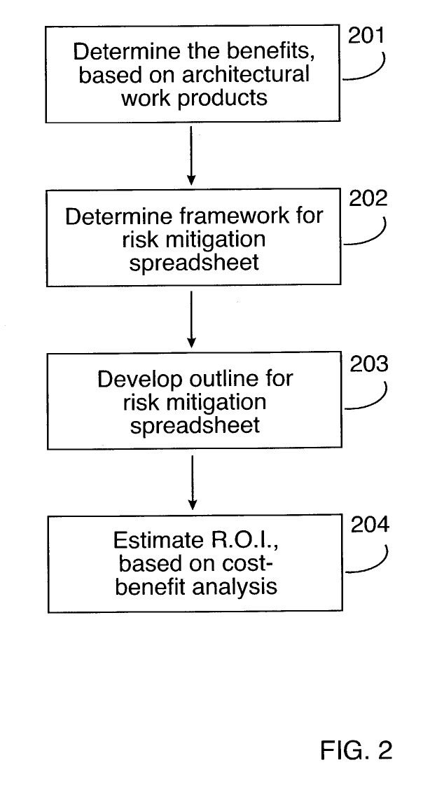

FIG. 2 is a flow chart showing an example of a process for estimating, according to the teachings of the present invention. To begin with an overview, this example involves determining benefits of an information-technology project, based on architectural work products (block 201), and estimating a return on investment for the project, based on a cost-benefit assessment (block 204). The estimating includes estimating cost quantities and benefit quantities for a plurality of years in the future. At least some of the benefits are mapped to at least some of the benefit quantities.

Turning to some details of FIG. 2, this example begins at block 201, determining the benefits. This may involve using existing architectural work products, or developing architectural work products. These typically include an architecture overview diagram, architecture decisions (which might include architecture principles), operational model/security architecture, and non-functional requirements, for example.

The architecture overview diagram represents the governing ideas and candidate building blocks of an information technology (IT) system and architecture. It provides an overview of the main conceptual elements and relationships in architecture, including candidate subsystems, components, nodes, connections, data stores, users and external systems. The main purpose of the architectural overview diagram is to communicate a simple, brief, clear, and understandable view of the target IT system. This type of diagram may be produced at several levels, including enterprise level, IT system level, and service level. At an enterprise level, an architectural overview diagram is often produced as part of an overall IT strategy. In this instance it is used to describe the vision of the business and IT capabilities required by an organization. It provides an overview of the main conceptual elements and relationships in architecture, including candidate subsystems, components, nodes, connections, data stores, users, external systems and a definition of the key characteristics and requirements. At an IT system and service level, the architectural overview diagram is produced very early in a project (possibly pre-proposal) and influences the component model and operational model.

TABLE 1
Example of architecture decisions

| | |
|---|---|
| Subject Area | Enterprise Message Format |
| Architectural | Format for messages handled by |
| Decision | interapplication |
| Problem | With the decision to use an Integration |
| Statement | Hub as the core of the enterprise systems |
| | integration, the next logical question is the |
| | format of the messages that can be |
| | handled by the hub. |
| Assumptions | The Integration Hub can translate any |
| | message format into one acceptable by |
| | the destination enterprise system. |
| Motivation | A well-defined message standard is one of |
| | the most important decisions to leveraging |
| | the benefits of using an Integration Hub. |
| | Essentially, the message standard |
| | becomes the published interface to the |
| | enterprise systems. |
| Alternatives | 1. EDI |
| | This alternative would utilize EDI |
| | messages across the Integration Hub. |
| | 2. XML |
| | This alternative would use an undefined |
| | XML message format. This format may be |
| | a published B2B “standard”, an e- |
| | business application's own message |
| | format, or a mix of the two. |
| | 3. Fixed Format |
| | This alternative would use messages in a |
| | fixed format, as defined by an e-business |
| | application. Examples would be comma- |
| | delimited messages or fixed position |
| | messages. An E-business application may |
| | choose to use a message format already |
| | accepted by one enterprise system. |
| Decision | Alternative #2, XML, will be used as the |
| | enterprise message format. |
| Justification | Although an e-business application may |
| | have extensive experience handling EDI |
| | messages, the EDI standard would greatly |
| | limit the types of messages that could flow |
| | through the system to those already |
| | defined in the EDI specification. However, |
| | this format should not be discarded for |
| | pilot systems that want to plug into the |
| | existing EDI infrastructure. |
| | XML, on the other hand, is completely |
| | self-defining and allows for great flexibility |
| | in defining message types. Furthermore, it |
| | is envisioned that the Integration Hub will |
| | be accessible by outside trading partners. |
| | An e-Business Application could adopt a |
| | B2B message standard for those external |
| | exchanges, because of XML's broad |
| | popularity in the B2B market. An e- |
| | Business Application could then |
| | supplement the standard for their internal |
| | messages, while still using the same XML |
| | parsing and translation software. |
| Implications | All enterprise applications will need to be |
| | able to translate the XML message format. |
| | Alternatively, translation rules would have |
| | to be established in the Integration Hub to |
| | translate the XML messages into a format |
| | the enterprise application can understand. |

Alternatively, translation rules would have to be established in the Integration Hub to translate the XML messages into a format the enterprise application can understand. Architectural decisions documents include important decisions about any aspect of the architecture, including the structure of the system, the provision and allocation of function, the contextual fitness of the system and adherence to the standards. Architecture principles are the underlying guidelines that hold true across the architecture. They define the essence of the architecture by capturing the thinking behind it, and provide a decision framework that enables the process of making decisions on the architecture. Architecture is understood partly through the record of important decisions made during its development. The justification and evaluation criteria are recorded along with the decision, or by reference to more generally acceptable principles, policies, and guidelines which are found in other work products or in external references.

The operational model work product focuses on describing the operations of an information technology (IT) system. This model is primarily derived from the non-functional requirements (or operational requirements). The operational model may include the following:

A logical diagram of the candidate nodes of the architecture and their connectivity. Nodes are potential hardware systems, though several nodes may be combined onto one physical system.

A description of each candidate node, including its purpose and contained software components.

Several views of architecture, including a network topology view, an availability/scalability view, a security view, a system management view, and a view of development and test environments.

A walkthrough of a set of business functions. The walkthrough demonstrates the interaction of both nodes and components to accomplish specific tasks.

Table 2 below provides an example of a non-functional requirements work product. The term “Non-functional Requirements” means more than just bare functions of a business process. All of the constraints on an IT system may be represented, including business constraints (e.g. geography of locations), IT standards, and current infrastructure constraints (e.g. must run on specified existing middleware). In addition, required properties such as portability and maintainability may be addressed here.

TABLE 2
Example of Non-functional Requirements

| | Will be used in | |
|---|---|---|
| | the future for | |
| | application or IT | Comments - |
| Topics | development? | benefits gained |
| Availability | Yes | Comments: |
| | | define availability |
| | | periods for data, |
| | | network. |
| | | Benefits: |
| | | mitigate down |
| | | time, minimize |
| | | manual |
| | | interaction, |
| | | reduce errors, |
| Backup & | Yes, | Benefits: |
| Recovery | Improvements | Standardization |
| | needed | of recovery |
| | | across all |
| | | applications, |
| | | mandate |
| | | referential |
| | | integrity (major |
| | | benefit) |
| Capacity | Yes, | Benefits: life |
| estimates and | Improvements | cycle application |
| planning | needed | requirements |
| | | planning, shared |
| | | resources |
| Configuration | Yes, Requires | Comments: |
| Management | automation for | Change |
| | entire | management |
| | development | processing |
| | community | requires |
| | | improvements |
| | | Benefits: Life |
| | | cycle |
| | | management, |
| | | reduced |
| | | involvement from |
| | | implementation |
| | | team, allow |
| | | appropriate |
| | | regression and |
| | | integration |
| | | testing |

Continuing with details of FIG. 2, at block 201, determining the benefits might involve other work products, such as a user profile, use case model, component model, business context model, system context model, or transition plan, for example. The following is a description of some other work products that may be used.

The user profile work product includes descriptions of users' prior knowledge and experience; physical characteristics; social and physical environment; jobs, tasks, and requirements; and cognitive characteristics. User Profiles classify the different types of users who will use a new system.

The use case model work product describes the functional requirements of the system under development. The model uses graphical symbols and text to specify how users in specific roles will use the system. The textual descriptions describing the use cases are from a user's point of view; they do not describe how the system works internally or its internal structure or mechanisms. A use case model may include:

Actors (name, description, status, subclass, superclass, and associations) Use cases (number, subject area, business event, name, overview, preconditions, description, associations, inputs, outputs, traceable to, usability index, and notes) Communication-associations between actors and use cases

Relationship between use cases (same as use case association)

Termination outcomes

Condition affecting termination outcome

Termination outcomes decision table

Use case scenarios (number, termination outcomes, descriptions, and notes)

Problem domain concept definitions

System steps decision table

Flow of event table

System sequence diagrams.

The component model work product describes the entire hierarchy of components in terms of their responsibilities; their interfaces, their (static) relationships, and the way they collaborate to deliver required functionality. A component is a relatively independent part of a system. It is characterized by its responsibilities and by interfaces it offers.

The business context diagram is a graphic depiction of relationships that exist among external entities and the business area or entity under consideration. It provides a “big-picture” understanding by showing external relationships with businesses and individuals in the marketplace. It consists of one or more diagrams that show the boundary of the enterprise. Entities can play various roles. The basic set of external entity roles includes consumers, distributors, suppliers, bankers, business partners, influencers, clearinghouses and regulatory bodies. The Business Context Diagram may represent both the established business relationships and those relationships that are in the process of being developed or are planned for the future. Inclusion of future relationships will allow a system under development to better address future needs of the enterprise.

The system context work product highlights important characteristics of the system, such as:

Users,

External systems,

Batch inputs and outputs,

External devices

External events to which the system must respond

Events that the system generates that affect external entities

Data that the system receives from the outside world and that must be processed in some way, and

Data produced by the system and sent to the outside world.

Continuing with details of FIG. 2, the example continues at block 202, determining a framework for a risk-mitigation spreadsheet. Determining a framework involves major decisions about a project, such as size and complexity, the time line for implementation, and the time line for return on investment, for example. This example involves utilizing a risk-mitigation spreadsheet as a tool for estimating a return on investment for a project, based on a cost-benefit assessment. A risk-mitigation spreadsheet is a tool that may be used to limit risk, such as the risk of failure of a project, or the risk of losing control of costs. Block 202 involves determining the general framework for estimation, based on the kind of project being considered. For example, a less complicated project might involve buying a standalone system, or hardware such as network switches and a midrange server. On the other hand, a more complicated project might involve building a major customer relationship management system, that requires a database, applications, reporting tools, an application integration environment, hardware and software, a network, people, and processes.

The example in FIG. 2 continues at block 203, developing an outline for a risk-mitigation spreadsheet. This is the detail-oriented phase of developing the risk-mitigation spreadsheet, based on the architectural work products. The result of the development effort at block 203 may be a reusable risk-mitigation spreadsheet, that is used by an organization in an ongoing fashion to evaluate current and future projects, for example. A reusable risk-mitigation spreadsheet may be adaptable to help an organization handle the technology aspects of company growth, a merger, or changing business priorities, for example.

The example in FIG. 2 continues at block 204, estimating a return on investment (ROI) for a project, based on a cost-benefit assessment. This estimating typically will include estimating cost quantities and benefit quantities for a number of years in the future. Typically, at least some of the benefits (determined at block 201) are mapped to benefit quantities. This estimating operation at block 204 may involve estimating a total cost of ownership (e.g. costs of hardware, software, maintenance, training, and technical support) for the project. This estimating operation at block 204 may involve estimating a ratio that compares the cost quantities and the benefit quantities for the project, for example. This estimating operation at block 204 may involve populating the risk-mitigation spreadsheet that was developed at block 203, and producing outputs that will guide decision-making for the project, for example.

Tables 3 and 4 below provide example layouts for a risk-mitigation spreadsheet.

TABLE 3
Example layout for a risk-mitigation spreadsheet

| Assessment | Year 1 | Year 2 | Year N |
|---|---|---|---|
| Assessment of | | | |
| benefits and | | | |
| costs of | | | |
| proposed | | | |
| project | | | |
| Assessment of | | | |
| benefits and | | | |
| costs of | | | |
| existing | | | |
| system | | | |
| (without | | | |
| proposed | | | |
| project) | | | |

TABLE 4
Example layout for a risk-mitigation spreadsheet

| | | | |
|---|---|---|---|
| Assessment of | Itemized | Itemized | Other costs |
| total benefits | major costs | major benefits | for Years 1-14 |
| and costs of | for Years 1-14 | for Years 1-14 | (e.g. |
| proposed | (e.g. | (e.g. | training costs) |
| project for | hardware | changes in | |
| Years 1-14 | lease and | revenue, | |
| | maintenance | labor costs, | |
| | charges, | and damage | |
| | charges for | claims) | |
| | design and | | |
| | implementation) | | |

These tables provide examples of how utilizing a risk-mitigation spreadsheet may involve representing the cost-benefit assessment, and representing the cost quantities, the benefit quantities, and a number of years. In Table 3, N represents any number of years, depending on the time frame for the estimate.

Table 4 provides some examples of benefit quantities that may be estimated: a change in revenue, a change in error rates (such as damage claims), and a change in labor costs. Consider an example of change in revenue; this may be an expected increase in revenue, due to increased customer satisfaction and customer loyalty. These benefits may be determined based on architectural work products, as described above in connection with FIG. 2, block 201. These benefits are mapped to benefit quantities in a cost-benefit assessment, and represented in a risk-mitigation spreadsheet. Starting with an Architecture Decisions work product (which might include Architecture Principles), one principle that may be documented is the utilization of a common look and feel, across all business solutions. This principle may provide improved simplicity, to address a current perception among a company's business partners and customers that doing business with the company is too complex. The use of a single brand image will improve awareness and overall brand loyalty. (The use of a common look and feel also will reduce training costs, both internally and externally.) This provides a basis for an expected increase in revenue, due to increased satisfaction and loyalty, among business partners and customers. This benefit is mapped to benefit quantities in a cost-benefit assessment, and represented in a risk-mitigation spreadsheet.

Consider another example. An architectural decisions work product provides a basis for an expected increase in revenue, due to increased satisfaction and loyalty among business partners. (See Table 1 above, which provides an example of an architecture decisions work product.) A decision is made and documented, that extensible markup language (XML) will be used as the enterprise message format. It is envisioned that the integration hub will be accessible by outside trading partners. Business applications could adopt a business-to-business (B2B) message standard for those external exchanges, because of XML's broad popularity in the B2B market. Data exchange with business partners is thus simplified. This benefit of using XML is mapped to benefit quantities, representing an increase in revenue, in a cost-benefit assessment.

Consider an example of a change in error rates, in the form of product damage claims. A use case model describes the process of a distributor ordering a company's products for resale. Possible termination outcomes are described. One of the possible outcomes is that due to an error of some kind, products are damaged, the distributor makes a claim for the damaged products, and the distributor is reimbursed. A use case model and other architectural work products may provide a basis for an expected decrease in damage claims (due to a decrease in error rates) and a reduction in labor costs (due to automated handling of damage claims). These benefits are mapped to benefit quantities in a cost-benefit assessment.

Continuing with details of FIG. 2, at block 204, Table 5 below provides an example of a summary of a cost-benefit assessment, from a risk-mitigation spreadsheet

TABLE 5
Example cost-benefit assessment

| | | Adjusted for |
|---|---|---|
| | Unadjusted | Present Value |
| Total benefits | $45,157,759 | $19,521,669 |
| Total costs | 7,241,326 | 4,554,000 |
| Cumulative net | 37,916,433 | 14,967,669 |
| benefits | | |
| Benefit/Cost ratio | | 4.3 |

Regarding FIG. 2, the order of the operations described above may be varied. For example, it is within the practice of the invention for block 201 (determining the benefits) to occur simultaneously with block 202 (determining the framework). Those skilled in the art will recognize that blocks in FIG. 2 could be arranged in a somewhat different order, but still describe the invention. Blocks could be added to the above-mentioned diagram to describe details, or optional features; some blocks could be subtracted to show a simplified example.

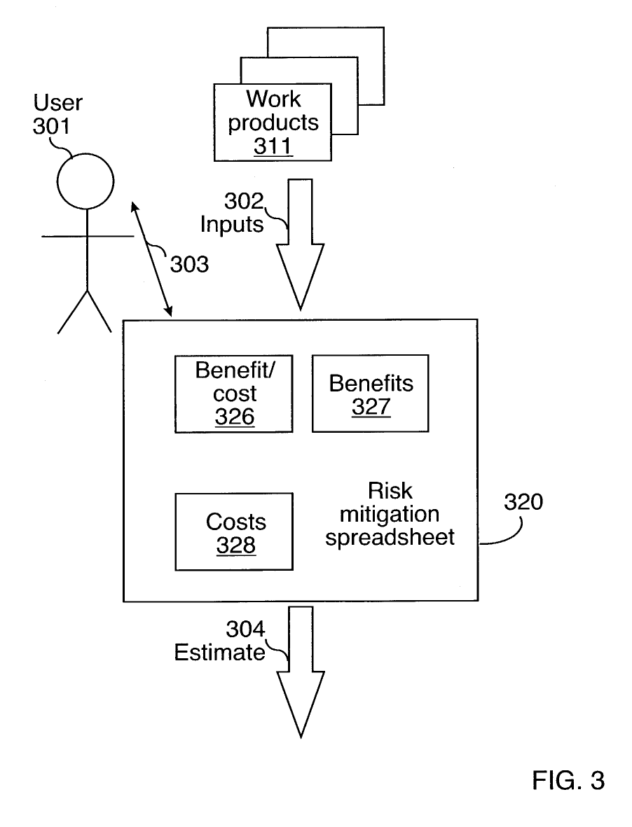

FIG. 3 is a block diagram showing an example of a system and method for estimating, according to the teachings of the present invention. To begin with an overview, FIG. 3 involves receiving inputs (at 302) from architectural work products (at 311), for an information-technology project, estimating a return on investment for the project, based on the inputs and on a cost-benefit assessment (shown at 326, within risk-mitigation spreadsheet 320), and outputting results (at 304).

Risk-mitigation spreadsheet 320 serves as a means for receiving inputs 302 for a project. Risk-mitigation spreadsheet 320 may be implemented at least in part with software running on a computer, or with printed instructions or a printed paperform, used with a hand-held calculator and pencil, for example. The double-headed arrow 303, connecting user 301 with risk-mitigation spreadsheet 320, symbolizes interactions between user 301 and risk-mitigation spreadsheet 320. For example, risk-mitigation spreadsheet 320 may give output to, and receive input from, user 301. Input devices such as keyboard, mouse, touch-sensitive screen, or microphone may be used. Inputs may come directly from user 301, from architectural work products 311, or from another source, such as stored data for a project. Risk-mitigation spreadsheet 320, and architectural work products 311, may be implemented with software running on the same computer, or on different computers that communicate via a network, for example. Risk-mitigation spreadsheet 320 may be implemented with spreadsheet software or database-management software, and may include a database, or may be connected to an external database.

In the example in FIG. 3, risk-mitigation spreadsheet 320 serves as a means for estimating a return on investment for the project, based on the inputs 302, and a cost-benefit assessment (represented in benefit/cost section 326). Risk-mitigation spreadsheet 320 serves as means for outputting results of the estimating (arrow 304 symbolizes output such as an estimated return on investment). Risk-mitigation spreadsheet 320 serves as means for estimating cost quantities (represented in costs section 328) and benefit quantities (represented in benefits section 327) for a number of years in the future. Risk-mitigation spreadsheet 320 may serve as means for estimating a total cost of ownership for the project. Risk-mitigation spreadsheet 320 may serve as means for estimating a ratio that compares the cost quantities and the benefit quantities for the project. Risk-mitigation spreadsheet 320 may serve as means for representing the cost-benefit assessment; and means for representing the cost quantities, the benefit quantities, and the years in the future. Rows and columns of numbers, or a graphical user interface with a layout similar to Table 3 or Table 4 may be used, for example.

Risk-mitigation spreadsheet 320 may be based on various return-on-investment metrics. Four common methods for calculating return on investment for IT projects are described below:

Treetop—These metrics investigate IT's impact (specifically on profitability) on the entire company. Profitability can take the form of cost reductions, because IT has the potential to reduce workforce size for any given process or task. Numerous back-office applications as well as e-learning packages have delivered measurable productivity improvements that contribute to the bottom line.

Pure Cost—Cost oriented views of IT's value include total cost of ownership (TCO) or Gartner Group's Normalized Cost of Work Produced (NOW) index. Gartner's NOW index measures the cost of an organization conducting a work task vs. the cost of others doing similar work. NOW index is also sometimes referred as Cost Recovery Method.

Holistic IT—This is achieved by using the balanced scorecard approach to running IT. Similar to a company-wide balanced scorecard, the IT organization establishes its own scorecard to align with company's mission and performance measures across four key indices: financial, customer, internal operations, and employee learning and innovation.

Financial—The value of new projects can be expressed in many different ways. An important measure concerning stakeholders is dollars gained or lost. Economic Value Added (EVA) is a measurement approach created by Stern Stewart & Co., that measures the dollar value added or lost on an investment, using Weighted Average Cost of Capital (WACC).

This final portion of the detailed description presents a few details of an example implementation. A risk-mitigation spreadsheet was implemented with spreadsheet software (the software product sold under the trademark LOTUS 1-2-3 by IBM) running on a laptop computer (sold under the trademark THINKPAD by IBM). Other hardware and software could be used. A risk-mitigation spreadsheet could be implemented as a client-server application, for example. In an example implementation, a layout similar to the example shown in Table 4 was used. This example risk-mitigation spreadsheet produced an estimate of a return on investment, for a large, application-integration project. A pure cost method was utilized. A summary similar to the example in Table 5 was presented for the project. Several architectural work products were utilized. The example in Table 1 is based on an excerpt from an Architecture Decisions document that was utilized in an example implementation.

In conclusion, examples of solutions are provided, for obtaining estimates of return on investment, for information-technology projects.

One of the possible implementations of the invention is an application, namely a set of instructions (program code) executed by a processor of a computer from a computer-usable medium such as a memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the method.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

I claim:

1. A method for estimating, said method comprising:
determining benefits of an information-technology project, based on architectural work products; and
estimating a return on investment for said project, based on a cost-benefit assessment;
wherein said estimating includes estimating cost quantities and benefit quantities for a plurality of years; and
wherein at least some of said benefits are mapped to at least some of said benefit quantities.

2. The method of claim 1, further comprising:
utilizing a risk-mitigation spreadsheet for said project.

3. The method of claim 2, wherein said risk-mitigation spreadsheet is reusable.

4. The method of claim 2, wherein said utilizing a risk-mitigation spreadsheet further comprises:
representing said cost-benefit assessment; and
representing said cost quantities, said benefit quantities, and said plurality of years.

5. The method of claim 2, wherein said utilizing a risk-mitigation spreadsheet further comprises:
developing said risk-mitigation spreadsheet, based on said architectural work products.

6. The method of claim 1, wherein said determining benefits further comprises:
developing said architectural work products.

7. The method of claim 1, wherein said estimating further comprises estimating a total cost of ownership for said project.

8. The method of claim 1, wherein said estimating further comprises estimating a ratio that compares said cost quantities and said benefit quantities for said project.

9. The method of claim 1, wherein one or more of said architectural work products are selected from the group consisting of:
an architecture overview diagram,
architecture decisions,
an operational model,
and non-functional requirements.

10. The method of claim 1, wherein one or more of said architectural work products are selected from the group consisting of:
a user profile,
a use case model,
a component model,
a business context model,
a system context model,
and a transition plan.

11. The method of claim 1, wherein said estimating further comprises estimating one or more items selected from the group consisting of:
a change in revenue,
a change in error rates,
and a change in labor costs.

12. A method for estimating, said method comprising:
receiving inputs from architectural work products, for an information-technology project;
estimating a return on investment for said project, based on said inputs and a cost-benefit assessment; and
outputting results of said estimating;
wherein said estimating includes estimating cost quantities and benefit quantities for a plurality of years.

13. The method of claim 12, further comprising:
developing said architectural work products.

14. The method of claim 12, wherein said estimating further comprises estimating a total cost of ownership for said project.

15. The method of claim 12, wherein said estimating further comprises estimating a ratio that compares said cost quantities and said benefit quantities for said project.

16. The method of claim 12, wherein said outputting results further comprises:
representing said cost-benefit assessment; and
representing said cost quantities, said benefit quantities, and said plurality of years.

17. A system for estimating, said system comprising:
means for receiving inputs from architectural work products, for an information-technology project;
means for estimating a return on investment for said project, based on said inputs and a cost-benefit assessment; and
means for outputting results of said estimating;
wherein said means for estimating includes means for estimating cost quantities and benefit quantities for a plurality of years.

18. The system of claim 17, wherein said means for estimating further comprises means for estimating a total cost of ownership for said project.

19. The system of claim 17, wherein said means for estimating further comprises means for estimating a ratio that compares said cost quantities and said benefit quantities for said project.

20. The system of claim 17, wherein said means for outputting results further comprises:
means for representing said cost-benefit assessment; and
means for representing said cost quantities, said benefit quantities, and said plurality of years.

21. A computer-usable medium having computer-executable instructions for estimating, said computer-executable instructions comprising:
means for receiving inputs from architectural work products, for an information-technology project;
means for estimating a return on investment for said project, based on said inputs and a cost-benefit assessment; and
means for outputting results of said estimating;
wherein said means for estimating includes means for estimating cost quantities and benefit quantities for a plurality of years.

22. The computer-usable medium of claim 21, wherein said means for estimating further comprises means for estimating a total cost of ownership for said project.

23. The computer-usable medium of claim 21, wherein said means for estimating further comprises means for estimating a ratio that compares said cost quantities and said benefit quantities for said project.

24. The computer-usable medium of claim 21, wherein said means for outputting results further comprises:
means for representing said cost-benefit assessment; and
means for representing said cost quantities, said benefit quantities, and said plurality of years.
